(19) United States
(12) Patent Application Publication
(10) Pub. No.: US 2015/0267835 A1
(43) Pub. Date: Sep. 24, 2015

(54) Compressed Air Tank Water Release Valve Sensor

(71) Applicant: William Jones, Irvine, CA (US)

(72) Inventor: William Jones, Irvine, CA (US)

(21) Appl. No.: 14/665,876

(22) Filed: Mar. 23, 2015

Related U.S. Application Data
(60) Provisional application No. 61/968,928, filed on Mar. 21, 2014.

(51) Int. Cl. F16K 31/02

(52) U.S. Cl. CPC F16K 31/02

(57) ABSTRACT

A valve monitoring system used for the evacuation of condensate from a compressed air tank includes a transducer that generates an electrical signal based on the sound of material exiting the tank through a release valve. When the electrical signal generated by the transducer corresponds to the sound of air flow, indicating that the condensate has been evacuated, a trigger mechanism actuates the valve to close the valve and prevent any additional air from exiting the tank.

This application claims priority to U.S. provisional application 61/968,928, filed Mar. 21, 2014. U.S. provisional application 61/968,928 and all other extrinsic references contained in this application are incorporated by reference in their entirety.

### FIELD OF THE INVENTION

The field of the invention is valve monitoring.

### BACKGROUND

The background description includes information that may be useful in understanding the present invention. It is not an admission that any of the information provided in this application is prior art or relevant to the presently claimed invention, or that any publication specifically or implicitly referenced is prior art.

Air tanks capable of holding compressed air are useful in many different applications. Compressed air can be used to fill car tires, fill bicycle tires, and inflate balls used in various sports. In addition, compressed air is used in industrial settings. In one application, compressed air is used as a duster to remove debris from mills and lathes as material is cut away from a piece of stock.

Compressed air is stored in hollow tanks These tanks are coupled with air pumps that force air into the tank until a target pressure is reached. Because air is humid, the process of compressing air into a closed container results in the accumulation condensed water. Depending on the weather conditions and, specifically, the level of humidity in the area where an air compressor operates, different amounts of water will condense.

When compressed air tanks are used frequently, accumulation of condensed water becomes problematic. Water can corrode interior portions of a compressed air tank and can also eventually reduce the volume of air the compressed air tank can hold. If left too long, the compressed air tank could even spray water out from its air output port when only air is desired.

To address this problem, water release valves are often placed on compressed air tanks An ideal water release valve allows water to escape from a compressed air tank without allowing compressed air to escape. One way of limiting the amount air that can escape from a compressed air tank is to use a sensor to collect and use information about the release valve.

The following descriptions include information that may be useful in understanding the present inventive subject matter. It is not an admission that any of the information provided in this application is prior art or relevant to the presently claimed invention, or that any publication specifically or implicitly referenced is prior art.

Some attempts have been made in the past to use sensors in conjunction with valves. For example, U.S. Patent Publ. No. 2012/0051186 to Holley discloses the use of acoustic sensors with undersea systems to detect valve position. Sensors measure acoustic properties of the valve while in a given position. When the valve's position changes, the acoustic properties of the valve change, making determination of valve position possible using only acoustic data. This system is leaves room for improvement, however, because the sensors disclosed in this publication do not provide information as to the matter passing through the valve.

U.S. Patent Publ. No. 2003/0116191 to Dobies discloses the use of piezoelectric transducers to acoustically detect the fluid level of condensate in a compressed air tank. When condensate within a compressed air tank reaches a certain level, an electronically controlled release valve is activated to allow the condensate to drain. The piezoelectric transducers disclosed in this publication act together as a speaker and microphone combination. The first transducer acting as a speaker generates sound and the second transducer acting as a microphone senses the sound. By detecting changes in the sound, the system detects whether condensate is disposed between the two transducers. However, the system disclosed in this publication leaves room for improvement because it requires at least two transducers and it does not directly detect any information about the valve. Additionally, this system requires components inside the compressed air tank, which adds to complexity, cost, and increases the risk of damaging parts by corrosion.

Still others have made efforts to efficiently expel condensate from compressed air tanks U.S. Patent Publ. No. 2013/0228156 to Pursifull also discloses a method of eliminating condensate from a compressed air tank through a release valve. However, in this publication condensate level is merely a predicted value. Again, this publication falls short because it does not disclose the use of a sensor to directly detect any information about the release valve.

Finally, some have solved the problem of condensate build-up in compressed air tanks by detecting the fluid level in the tank using a float sensor. U.S. Pat. No. 5,417,237 to Stumphauzer et al. Once the fluid level is known, the valve can be opened for a set duration to expel the fluid. This patent discloses the use of a float sensor to detect fluid level within a pneumatic tank. Based on the fluid level the sensor detects, a valve can be activated allowing the built-up fluid to drain from the tank. This design, however, still does not directly gather any information from the valve itself, making the duration the valve remains open a function of time.

All publications or patents identified in this application are incorporated by reference to the same extent as if each individual publication or patent application were specifically and individually indicated to be incorporated by reference. Where a definition or use of a term in an incorporated reference is inconsistent or contrary to the definition of that term provided in this application, the definition of that term provided in this application applies and the definition of that term in the reference does not apply.

The following description includes information that may be useful in understanding the present invention. It is not an admission that any of the information provided in this application is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

The recitation of ranges of values in this application is merely intended to serve as a shorthand method of referring individually to each separate value falling within the range. Unless otherwise indicated in this application, each individual value is incorporated into the specification as if it were individually recited in this application. All methods described in this application can be performed in any suitable order unless otherwise indicated in this application or otherwise clearly contradicted by context. The use of any and all examples, or exemplary language (e.g. “such as”) provided with respect to certain embodiments in this application is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed in this application are not to be construed as limitations. Each group member can be referred to and claimed individually or in any combination with other members of the group or other elements found in this application. One or more members of a group can be included in, or deleted from, a group for reasons of convenience and/or patentability. When any such inclusion or deletion occurs, the specification is in this application deemed to contain the group as modified thus fulfilling the written description of all Markush groups used in the appended claims.

Thus, there is still a need for a valve monitoring system for compressed air tanks.

### SUMMARY OF THE INVENTION

The inventive subject matter provides apparatus, systems and methods in which a valve monitoring system is used with a compressed air tank to detect when a release valve on the tank has been open long enough to expel condensed water that has accumulated in the tank.

In one preferred aspect, a valve monitoring system uses a transducer to detect when a release valve changes from releasing predominantly liquid to releasing predominantly gas. In the context of compressed air tanks liquid refers to condensed water that accumulates in the tank, and gas generally refers to air. However, it is contemplated that the system will function regardless of the fluid and gas involved.

It is contemplated that release valves commonly known in the art can be used with the system. Modes of valve actuation include mechanical (e.g., converting rotary motion into linear motion), electrical (e.g., converting electrical energy into mechanical torque), pneumatic (e.g., converting energy from compressed air into either linear or rotary motion), and hydraulic (e.g., using incompressible fluids to actuate a piston). In preferred embodiments, the valve is a solenoid actuated type of valve. A solenoid-actuated valve is one that a solenoid can open and/or close. In embodiments, the valve in its rest state is closed and the solenoid causes the valve to open, while in others the rest state of the valve is open and the solenoid closes the valve. In still other embodiments, valves are both opened and closed by one or more solenoids.

When the release valve on an air tank holding compressed air is in an open position, both liquid and gaseous matters in the tank can be forcefully pushed out, making a sound. The sound created in this process is different when a valve is releasing water compared to when a valve releases air. When water has condensed inside a compressed air tank, the water is released through a valve until eventually the valve releases only air. However, this transition does not occur instantaneously. Instead, the change in sound occurs gradually and in phases. In a first phase only water passes through the valve, making a first sound. In the next phase, as the water in the tank is released, eventually a mixture of water and air begins to pass through the valve, making a second sound. At the start of this phase, the mixture of air and water passing through the valve is predominantly water, but gradually changes as the mixture of water to air expelled shifts to being predominantly air. In a third phase, the mixture of air and water passing through the valve is almost entirely air, making a third sound.

In preferred embodiments, a transducer detects the changes in sound described above, and determines approximately when during the second phase the mixture of air and water passing through the valve changes from predominantly water to predominantly air. To do this, the transducer converts sound energy into an electrical signal. The signal corresponds to the sounds emitted from the valve, so as the sound from the valve changes the electrical signal changes respectively.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is an illustrative overview of a compressed air tank including the valve monitoring system of the inventive subject matter.

FIG. 1A is a cross-sectional view of the tank of FIG. 1

FIG. 2 is an illustrative overview of embodiments incorporating a processor into the valve monitoring component of the system.

FIG. 3A is an illustrative overview of embodiments incorporating a band-pass filter into the valve monitoring component of the system.

FIG. 3B is a variation of the embodiments shown in FIG. 3A, including a rectifier and amplifier.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Throughout the following discussion, references may be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

As used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The disclosed techniques of the inventive subject matter allow for the evacuation of water or other liquid from an air tank while minimizing the loss of air from the tank.

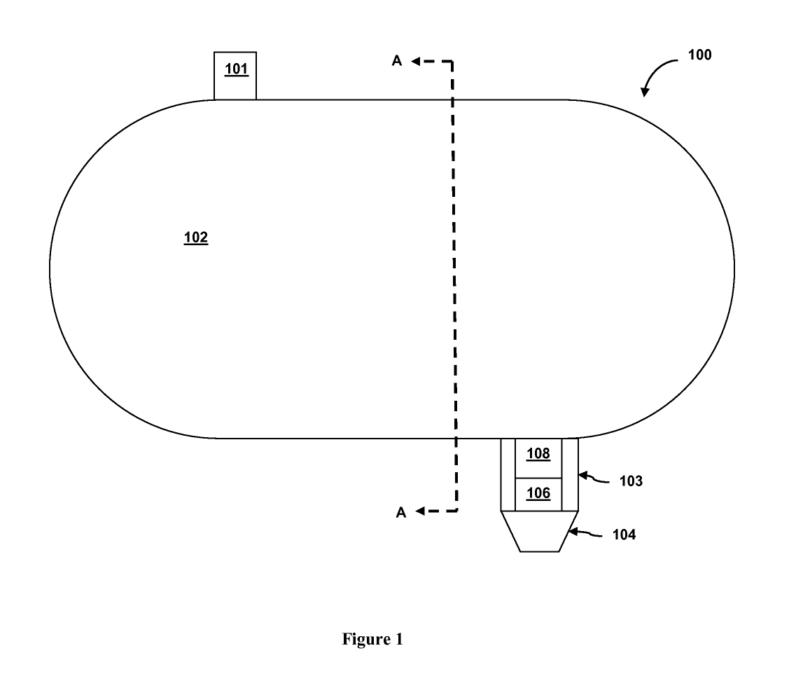

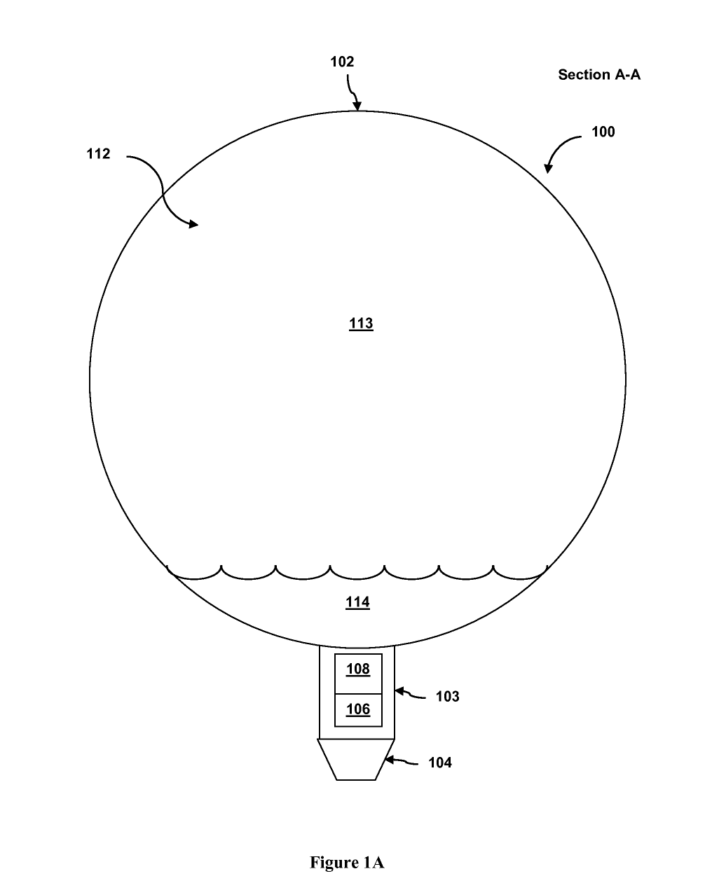

FIG. 1 shows a compressed air tank 100 has a filling valve 101, a housing 102, a release valve 104, and a valve monitoring component 103. As used in this application, references to the “valve monitoring system” can be considered to refer to the combination of the valve monitoring component 103 and the release valve 104.

The valve monitoring component 103 includes a trigger mechanism 106 configured to actuate the release valve 104, and a transducer 108 capable of converting mechanical vibrations (e.g. sound, vibration of the housing 102 near or at the release valve 104, etc.) into an electrical signal. Examples of suitable transducers 108 can include microphones, piezoelectric transducers, etc. In preferred embodiments, transducer 108 is a passive transducer that does not require an emission of a signal from the transducer itself (or a separate sound-generating transducer) to detect sound.

Transducer 108 is connected to trigger mechanism 106 such that an electrical signal from transducer 108 causes the trigger mechanism 106 to actuate release valve 104, as will be described in further detail below. The actuation of release valve 104 by trigger mechanism 106 in response to a signal from transducer 108 causes the release valve 104 to close and prevent any additional material (e.g. liquid or gas) from exiting tank 100 via release valve 104.

FIG. 1A shows a cutaway view of the compressed air tank of FIG. 1. The housing 102 of the compressed air tank 100 defines an interior space 112 that contains compressed gas (e.g., compressed air) 113 and, occasionally, condensate 114. As condensate 114 accumulates within the interior space 112, it becomes necessary to evacuate the condensate 114 from the interior space 112 of tank 100. As discussed in this application, “compressed gas” and “compressed air” are intended to refer to a gas within the interior space 112 that is at a greater pressure than the environment outside of tank 100 (either a gas environment or a liquid environment).

In embodiments, the valve 104 in its rest state is closed and the trigger mechanism 106 causes the valve 104 to open, while in other embodiments the rest state of the valve 104 is open and the trigger mechanism 106 closes the valve 104. In still other embodiments, valve 104 can be both opened and closed by one or more trigger mechanisms 106.

In embodiments, such as the embodiment described in this application for illustrative purposes, the release valve 104 is a solenoid-actuated type of release valve. A solenoid-actuated valve is one that a solenoid can open and/or close. Thus, in these embodiments, the trigger mechanism 106 is a solenoid.

In embodiments, release valve 104 used with the systems and methods of the inventive subject matter can include other types of release valve actuation mechanisms commonly known in the art. Suitable trigger mechanisms 106 used for valve actuation can include mechanical actuation (e.g., converting rotary motion into linear motion), electrical actuation (e.g., converting electrical energy into mechanical torque), pneumatic actuation (e.g., converting energy from compressed air into either linear or rotary motion), and hydraulic actuation (e.g., using incompressible fluids to actuate a piston). Thus, it should be noted that the term “solenoid” is used interchangeably with “trigger mechanism” in this application for the purposes of illustration and should not be interpreted as excluding other types of trigger mechanisms (such as the examples mentioned in this application) unless specifically noted.

To evacuate the condensate 114 from the interior space of the tank 110, the solenoid 106 opens the release valve 104. It is contemplated that the release valve 104 can be opened via manual activation of the actuation mechanism (e.g., the solenoid 106 illustrated in FIGS. 1 and 1A), in response to a detected trigger condition or other automated system to detect the presence of condensate 114 within tank 100 (e.g., a sensor (not shown) located at a certain level of the interior 112 of tank 100 that is activated by contact with condensate 114, triggering the activation of solenoid 106 to open release valve 104), and/or opened according to a periodic (and/or scheduled) timer-based activation (which can be user-defined or user-programmed) such that the release valve 104 is opened periodically. It should be noted, however, that regardless of the mechanism used to actuate the release valve 104 to open, the closure of the release valve 104 occurs according to the methods and systems of the inventive subject matter described in this application.

Because the condensate 114 is of a greater density than the compressed air 113, the condensate 114 will typically sit at the bottom of the housing 102 of tank 100 and tend to proceed through the open release valve 104 before the compressed gas 113 (being forced out by the compressed gas 113). However, when the release valve 104 on an air tank 100 holding compressed air 113 is in an open position, both liquid and gaseous matters in the tank can be forcefully pushed out either simultaneously or separately. Thus, when the release valve 104 is opened, the condensate 114 is released through release valve 104. Initially, the material released is typically entirely condensate 114 (or nearly entirely so). As the condensate 114 is released, the material passing through release valve 104 can be a mixture of condensate 114 and gas (e.g., gas trapped within condensate 114 and/or air 113 passing through the release valve 104 simultaneously with condensate 114), especially as the amount of condensate 114 remaining within tank 100 approaches exhaustion. Eventually, the release valve 104 releases only air 113 because the condensate 114 has been evacuated from the tank 100.

When matter (either condensate 114 or air 113, or a mixture of both) is evacuated from tank 100 via valve 104, the evacuation generates a sound. As used in this application, “sound” is intended to refer to the propagation of compression waves through a medium, causing the medium to vibrate such that the vibrations are perceptible to transducer 108. Sound may be audible or inaudible to the naked human ear, depending on frequency and/or intensity. The sound generated during this process is different when valve 104 is releasing a liquid (e.g. condensate 114 such as water) compared to when the valve 104 releases air. However, this transition does not occur instantaneously. Instead, the change in sound occurs can occur gradually and in phases.

In a first phase, the matter passing through release valve 104 will be entirely condensate 114 (or almost entirely condensate), making a first sound. Because the condensate 114 is being “pushed” out of tank 100 by the pressure of the compressed air 113 coming behind it and the pressure of compressed air 113 will not change significantly during this phase, the frequency and/or amplitude of the first sound can be considered to remain generally consistent and uniform during the first phase.

In the second phase, as the condensate 114 in the tank 100 is released, eventually a mixture of condensate 114 and air 113 begins to pass through the release valve 104, making a second sound. At the start of this phase, the mixture of condensate 114 and air 113 passing through the valve 104 is predominantly condensate 114, but gradually changes as the mixture of water to air expelled shifts to being predominantly air 113. The second sound can be characterized by (a) frequent changes in frequency and/or amplitude (e.g., sputtering sounds), or (b) gradual changes in frequency and/or amplitude as condensate is expelled (e.g., an absence of sputtering).

Sputtering can be caused by a mixture of both air and liquid exiting the tank 100 (for example, pockets of air 113 ejected while the expelled matter is primarily condensate 114, causing interruptions in condensate-produced sound or, alternatively, small amounts of condensate 114 interrupting a mostly gaseous flow as the amount of condensate 114 decreases within tank 100), turbulent flow of the condensate 114 caused by air 113 within the condensate 114, or other effects of having a flow of a combination on of condensate 114 and air 113 exiting through the valve 104.

In a third phase, the matter passing through the valve 104 is entirely (or almost entirely) air 113, making a third sound. The frequency and/or amplitude of the third sound will decrease over time as the pressure of the compressed air 113 within tank 100 decreases. However, for relatively short periods of time during which the change in pressure within tank 100 is relatively small, the third sound can be considered to be consistent in terms of frequency and/or amplitude.

As used in the description of the first phase and third phase, the terms “entirely”, “nearly entirely” and “almost entirely” in reference to the composition of the flow passing through the release valve 104 are intended to refer to a composition of condensate 114 to air (in the first phase) and a composition of air 113 to condensate 114 (in the third phase) such that the sound generated by the flow results in an electrical signal whose characteristics (e.g., amplitude, frequency, etc.) are a priori observed to remain consistent and uniform within acceptable tolerances and thresholds. Thus, for example, if for a tank 100 a flow is observed passing through valve 104 under controlled conditions that is a priori known to be sufficiently composed of air 113, the resulting electrical signal produced by transducer 108 will have relatively consistent characteristics with perhaps an occasional variance due to the occasional, infrequent presence of trace amounts of condensate 114 within the flow of air 113 through valve 104. Thus, the occasional variance can be incorporated into determining the tolerances of variance of the electrical signal such that an electrical signal from the transducer 108 that is sufficiently uniform and consistent within these tolerences can be considered to be the product of “entirely” condensate 114 or air 113 flows in phases one or three, respectively. From these observations, the allowable amounts of air present within a flow of condensate 114 (in phase one) and condensate 114 present within a flow of air 113 (in phase three) such that the flow can be considered to be “entirely” condensate 114 or air 113, respectively, can be determined. This approach allows for the precise setting of an acceptable level of condensate or air (for phases one and three, respectively) given the particular characteristics of a tank 100, the valve 104, the condensate 114 (e.g., condensate is water or another liquid), the gas 113 (e.g., gas is air or other gas), etc.

In embodiments, the amount of condensate 114 to air (for phase one) for the flow to be considered entirely condensate 114 is at least 75% condensate. In embodiments, this amount of condensate 114 is at least 80% condensate. In embodiments, this amount of condensate 114 is at least 90% condensate. In embodiments, this amount of condensate 114 is at least 95% condensate. In embodiments, this amount of condensate 114 is at least 99% condensate.

In embodiments, the amount of air 113 to condensate 114 (for phase three) for the flow to be considered entirely air 113 is at least 75% air. In embodiments, this amount of air 113 is at least 80% air. In embodiments, this amount of air 113 is at least 90% air. In embodiments, this amount of air 113 is at least 95% air. In embodiments, this amount of air 113 is at least 99% air.

The term “predominantly” can be considered to reference “more than half”, and more preferably, more than half but less than the proportion of air/condensate or condensate/air mix that provides an acceptable electrical signal used to interpret the flow as “entirely condensate” or “entirely air” in phases one and three, respectively. For example, a mixture where a first substance makes up more than 50% of the mixture by volume is predominantly the first substance. Thus, a predominantly air mixture is more than 50% air by volume.

The distinction or boundary between the first phase and second phase can be considered to be the point at which the principally consistent and uniform sound (the first sound) generated by a flow made up entirely (as described above) of condensate 114 transitions to an inconsistent, non-uniform, “sputtering” sound generated by a flow made up of predominantly condensate 114 disrupted by gas, as described in the description of the second phase. The distinction or boundary between the second phase and third phase can be considered to be the point at which the principally inconsistent, non-uniform, “sputtering” sound produced by the phase two flow (caused by a mixture of air 113 and condensate 114 sufficient to disrupt a smooth flow of air through valve 104) transitions to the uniform, consistent sound made by a flow of entirely air 113 (as described above).

For a tank 100 having an opening (open valve 104) of a static area, the third sound (generated by escaping compressed air 113) is generally going to have a higher frequency and/or amplitude than the first sound (generated by escaping condensate 114), and will generally be more consistent and uniform in terms of frequency and/or amplitude than the second sound.

In preferred embodiments, valve monitoring component 103 detects when the condensate 114 has been evacuated and closes the release valve 104 to minimize the amount of pressurized air 113 escaping from tank 100 by closing the release valve 104 when the sound generated by the evacuating matter reaches the third phase, producing the third sound associated with predominately escaping air 113.

As matter passes through open release valve 104, transducer 108 detects the sounds generated by the material passing through the open release valve 104 and converts the sounds into electrical signals. As the sound changes, the electrical signal emitted by transducer 108 will change accordingly.

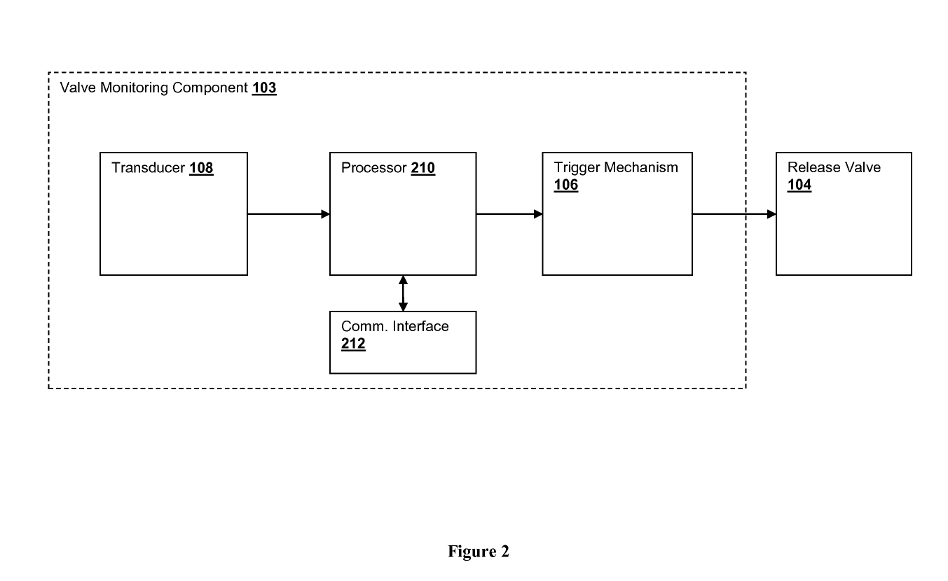

In embodiments such as those illustrated in FIG. 2, the valve monitoring component 103 can include a circuit including a programmable hardware processor 210 logically positioned between and communicatively coupled to the transducer 108 and the trigger mechanism 106. The processor 210 can be programmed to receive the electrical signal from transducer 108 and compare the electrical signal to threshold signal values representative of electrical signal values associated with the sound of predominately air passing through the release valve 104 (i.e., the third sound). Upon determining that the electrical signal has crossed the threshold, the processor 210 sends a signal to the trigger mechanism 106 (e.g. an electrical signal sufficient to activate the trigger mechanism 106) that actuates the closure of the release valve 104 (e.g., via the solenoid).

In embodiments, the variations in sound across the three phases for a plurality of different internal pressures of pressurized gas 113 can be externally observed and recorded such that the sounds can be correlated to the correct phase/characteristics of the material escaping through release valve 104. Thus, the processor can be programmed with a plurality of threshold values. In these embodiments, the processor can be communicatively coupled with pressure sensors or other sensors that provide an indication of the pressurized air 113 within tank 100, and can select the threshold value corresponding to an observed pressure received from the pressure sensor.

In embodiments, the threshold signal value can include a duration element such that the processor is programmed to actuate the closing of the release valve 104 only if the electrical signal from the transducer 108 exceeds the threshold value for a minimum amount of time without crossing back below the threshold value. The inclusion of a duration element in the threshold signal value helps reduce the likelihood that the valve 104 is closed due to a “false positive” of the electrical signal reaching the threshold value while the flow exiting through valve 104 is still in phase two (i.e., an amount of condensate 114 remains within tank 100 and has not finished being evacuated). Contemplated duration amounts for the duration element of the threshold signal value include 0.5 seconds, 1 second, 2 seconds, 5 second, and other durations of time less than 5 seconds adjustable to tenths of a second.

In embodiments, the circuit and/or processor 210 of valve monitoring component 103 can include wireless and/or wired communication interface 212 (e.g., USB, HDMI, WiFi, BlueTooth, etc.) that enable the processor 210 to be updated with additional threshold values, updated triggering instructions, etc., communicated from an external computing device.

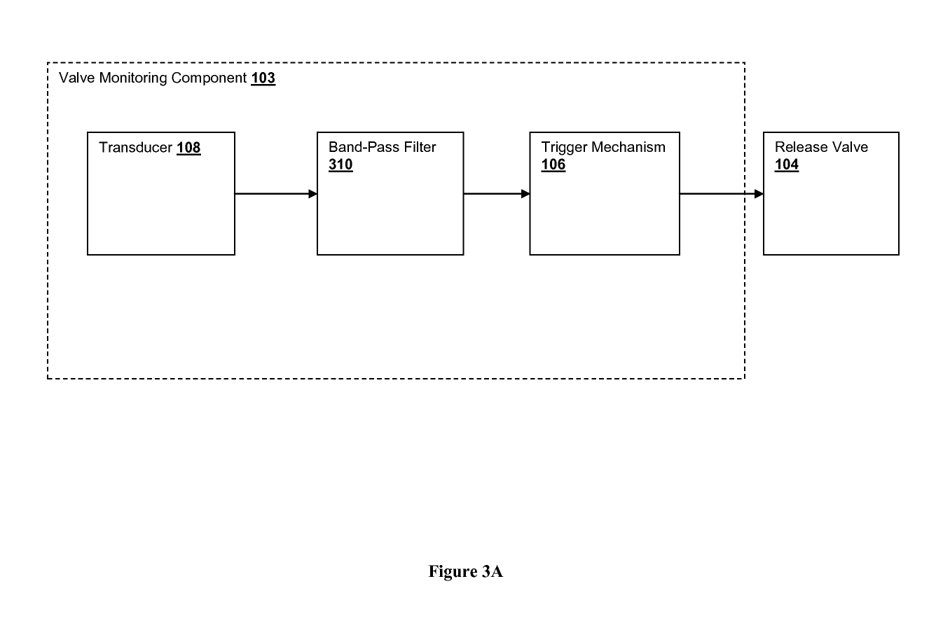

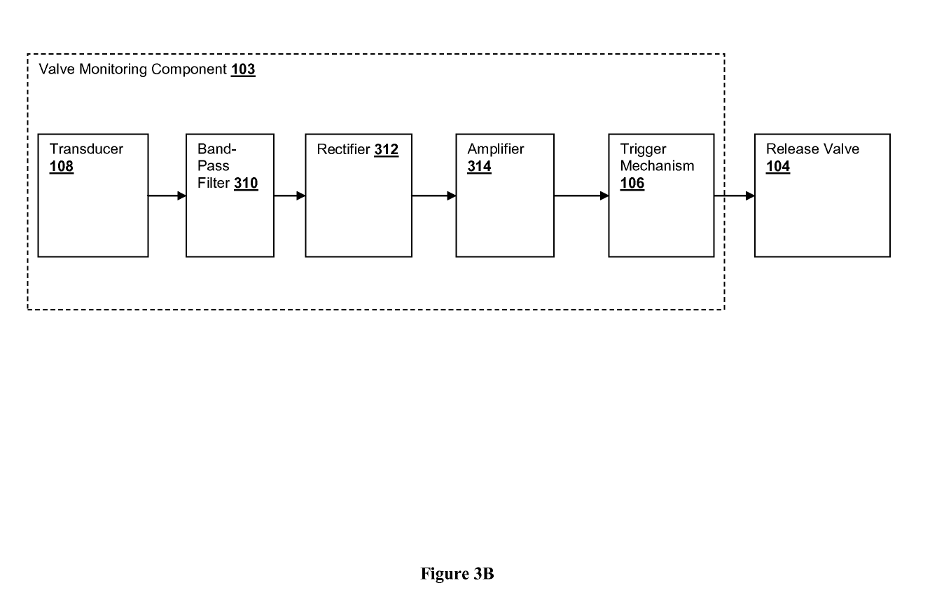

In embodiments, such as those illustrated in FIG. 3A, the valve monitoring component 103 can include a band-pass filter 310, and the trigger mechanism 106 can include a switch (such as a transistor or a relay). In these embodiments, the band-pass filter 310 (e.g., an RLC circuit) is configured to allow only signals having frequencies within a specified range, such as the electrical signal having a frequency corresponding to the third sound, to pass from the transducer 108 to the switch. Thus, only the electrical signal corresponding to the third sound (made by predominantly gas 113 exiting through valve 104 in the third stage as discussed above) is passed onward. The electrical signal that is passed onward goes on to activate the switch, causing the trigger mechanism 106 to actuate the valve 104 to close it. In these embodiments, the valve monitoring component 103 can further include a rectifier and an amplifier as needed to provide sufficient current to the trigger mechanism 106 to cause the closure of valve 104 (illustrated in FIG. 3B).

In embodiments where the band-pass filter 310 used is an RLC circuit, it is contemplated that the RLC circuit can be a variable RLC circuit (e.g., electronically variable, mechanically variable, etc.), such that the valve monitoring component 103 can be adjusted to be sensitive to different sound qualities (e.g., frequency and/or amplitude) which are subsequently reflected in the electrical signal generated by the transducer 108. The RCL circuit can include any combination of variable resistors, variable capacitors, and variable inductors such that the range of frequencies allowed to pass through the filter can be adjusted to suit a particular application. The resistors, capacitors, and inductors can all be varied mechanically, electrically, or otherwise.

The threshold value(s) (for embodiments using processors) and/or the desired electrical signal characteristics (for the band-pass filter embodiments) can be determined a priori via measurement of the sounds made by the evacuation of tank 100 that is being externally observed for condensate 114 and compressed gas 113, such that the recorded values of sound and their corresponding electrical signals generated by transducer 108 are observed and recorded (such as in a non-transitory computer-readable storage medium). As such, accurate values for a particular tank 100 and valve 104 of particular sizes and materials can be observed and recorded.

It is contemplated that the determination of the third sound (i.e., of predominately air passing through valve 104) can be governed by measurements of frequency of the sound, amplitude of the sound, or a combination both frequency and amplitude. Because the transducer 108 generates an electrical signal whose frequency and amplitude reflect the respective properties (frequency and amplitude) of the detected sound.

For example, in embodiments where the valve monitoring component 103 includes a processor, the trigger threshold can be: a threshold frequency that the frequency of the electrical signal from the transducer 108 must exceed to actuate the trigger mechanism 106; a threshold amplitude that the amplitude of the electrical signal from the transducer 108 must exceed to actuate the trigger mechanism 106; or a combination of a threshold frequency and a threshold amplitude, both of which must be exceeded simultaneously by the frequency and amplitude of the signal from transducer 108 to actuate the trigger mechanism 106.

Unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

It should be apparent to those skilled in the art that many more modifications besides those already described are possible without departing from the inventive concepts in this application. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A valve monitoring system for use with a compressed air tank, comprising:
a release valve;
a transducer configured to detect a sound generated by a flow of material passing through the release valve when the release valve is open and convert the sound into an electrical signal representative of the sound; and
a valve monitoring component coupled to the transducer and the release valve, the valve monitoring component configured to close the release valve in response to the electrical signal corresponding to sound generated by the flow of material such that the material is air.

2. The valve monitoring system of claim 1, wherein the release valve is a solenoid-actuated type of valve.

3. The valve monitoring system of claim 1, wherein the transducer comprises an acoustic piezoelectric sensor.

4. The valve monitoring system of claim 1, wherein the transducer comprises a microphone.

5. The valve monitoring system of claim 1, wherein the valve monitoring component comprises a processor and a trigger mechanism, wherein the processor is coupled to the transducer and the trigger mechanism, and is programmed to:
receive the electrical signal from the transducer;
determine that the electric signal exceeds a threshold signal value, the threshold signal value representative of air flowing through the release valve; and
upon determining that the electric signal exceeds the threshold signal value, cause the trigger mechanism to close the release valve.

6. The valve monitoring system of claim 5, wherein the processor is further programmed to determine that the electrical signal exceeds a threshold signal value for a threshold duration of time and upon determining that the electric signal exceeds the threshold signal value for the threshold duration of time, cause the trigger mechanism to close the release valve.

7. The valve monitoring system of claim 1, wherein electrical signal includes a frequency dimension and the valve monitoring component comprises:
a band-pass filter coupled to the transducer, wherein the band-pass filter is configured to only allow an electrical signal having a frequency associated with a sound of air flowing through the release valve to pass; and
a trigger mechanism configured to close the release valve in response to receiving an electrical signal from the band-pass filter.

8. The valve monitoring system of claim 7, further comprising a rectifier and an amplifier logically positioned between the band-pass filter and the trigger mechanism.

9. The valve monitoring system of claim 7, wherein the band-pass filter comprises an RLC circuit.
